(19) United States
(12) Patent Application Publication
(10) Pub. No.: US 2011/0295693 A1
(43) Pub. Date: Dec. 1, 2011

(54) Generating Tailored Content Based On Scene Image Detection

(75) Inventors: John Clavin, Seattle, WA (US); Aaron Kornblum, Mercer Island, WA (US)

(73) Assignee: MICROSOFT CORPORATION, Redmond, WA (US)

(21) Appl. No.: 12/791,646

(22) Filed: Jun. 1, 2010

(51) Int. Cl. G06Q 30/00; G06K 9/68

(52) U.S. Cl. 705/14.66; 382/218

(57) ABSTRACT

A method for generating tailored content for a user based on analyzing images of a scene is provided. Images from a scene captured by a capture device of a target recognition and analysis system are received. The images are analyzed to detect one or more brand identifiers in the images. In an embodiment, the brand identifiers include symbols or words identifying a brand, product or service associated with the brand identifier. The detected brand identifiers are compared to one or more known brand identifiers and user preference information is assigned to the detected brand identifiers based on the comparison. Tailored content is generated for the user based on the user preference information. The tailored content is rendered on a display device to the user.

### BACKGROUND

Many computing applications such as computer game applications and multimedia applications allow users to view various types of content during a game. In-game advertising includes the placement of advertisements in video game applications while the user is engaged in a game. Techniques for placing advertisements in a game may typically include determining a user's preference towards a particular product, service or event by making average assumptions about the type of users who typically view or experience a particular type of content. For example, information that a particular type of content may be viewed or experienced by a certain age group of users may be used to determine an individual user's preference while delivering advertising content to the user during gameplay.

### SUMMARY

Technology is disclosed by which tailored content may be generated for a user based on detecting items of interest in scene images captured by an image capture device in a target recognition, analysis, and tracking system executing an application. Tailored content is generated for the user based on assigning user preference information to the items of interest detected in the scene images. A customized and enhanced experience may be provided to the user of the target recognition, analysis and tracking system based on the tailored content.

In one embodiment, a method for generating tailored content for a user based on analyzing images from a scene is disclosed. Images from a scene captured by a capture device of a target recognition and analysis system are received. The images are analyzed to detect one or more brand identifiers in the images. In an embodiment, the brand identifiers include symbols or words identifying a brand, product or service associated with the brand identifiers. The detected brand identifiers are compared to one or more known brand identifiers and user preference information is assigned to the detected brand identifiers based on the comparison. Tailored content is generated for the user based on the user preference information. The tailored content is rendered on a display device to the user.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIGS. 1A and 1B illustrate an example embodiment of a target recognition, analysis, and tracking system with a user playing a game.

FIG. 2 illustrates an example embodiment of a capture device that may be used in a target recognition, analysis, and tracking system.

FIG. 3 is an exemplary functional block diagram of a computing environment that may be used in a target recognition, analysis and tracking system.

FIG. 4 illustrates another example embodiment of a computing environment that may be used in a target recognition, analysis, and tracking system.

FIG. 5 is an example embodiment of the operation of the target recognition and analysis system shown in FIGS. 1A-2 in a larger network community, in accordance with the disclosed technology.

FIG. 6 illustrates an exemplary set of operations performed by the disclosed technology to generate tailored content for a user based on analyzing images in a scene captured by a capture device in the target recognition and analysis system.

FIG. 7 illustrates an exemplary set of operations performed by a network gaming service to generate tailored content for a user.

### DETAILED DESCRIPTION

Technology is disclosed which improves a user's experience while interacting with a target recognition and analysis system executing an application. An image capture device in the target recognition and analysis system captures images of a scene that include one or more users and objects. In a first set of operations performed by the disclosed technology, the images of the scene are analyzed to detect one or more items of interest in the images. In an embodiment, the items of interest may include one or more brand identifiers in the images. User preference information is assigned to the brand identifiers based on the analysis. In a second set of operations performed by the disclosed technology, the user preference information is analyzed to generate tailored content for the user. The tailored content may include, for example, providing a targeted product advertisement or a targeted broadcast event for the user. The tailored content is displayed on a display device of the target recognition, analysis, and tracking system to the user.

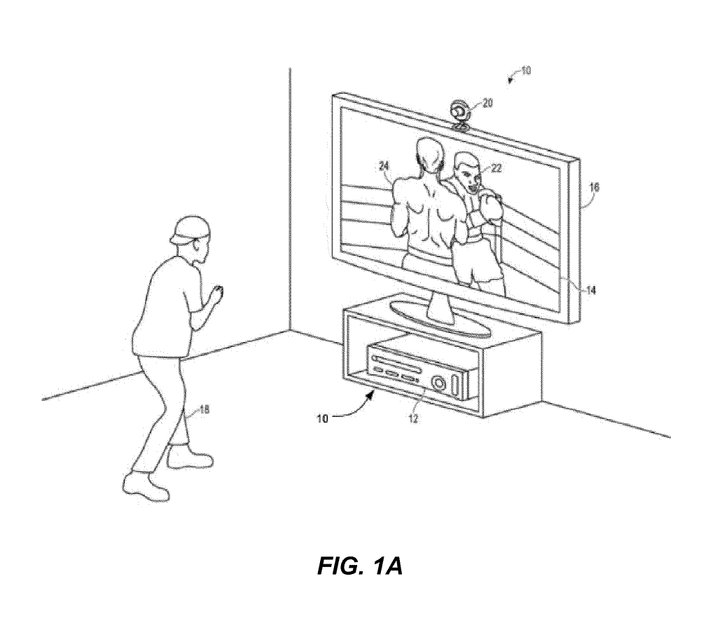

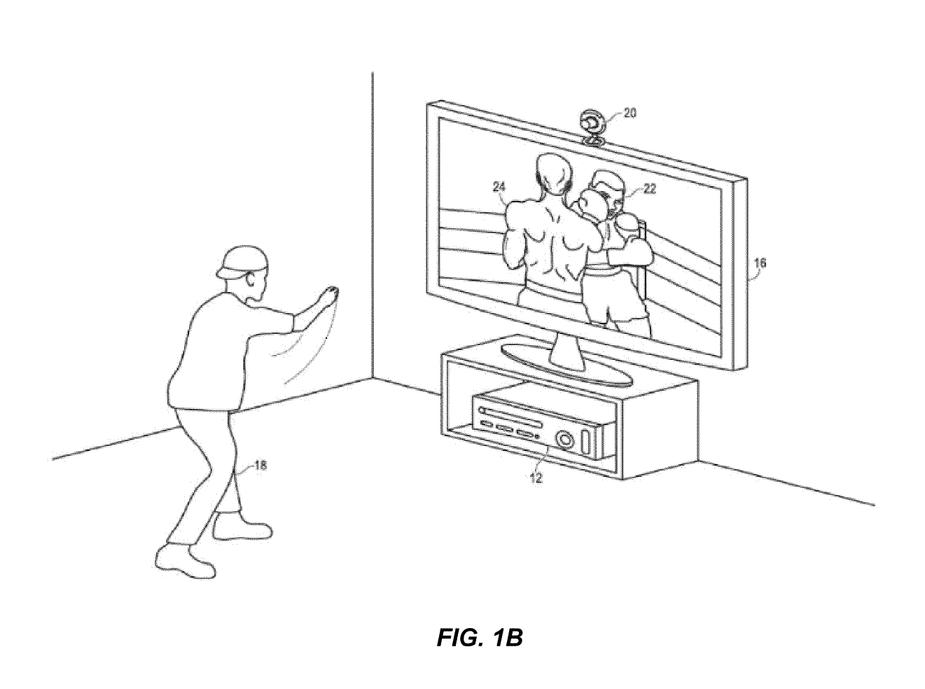

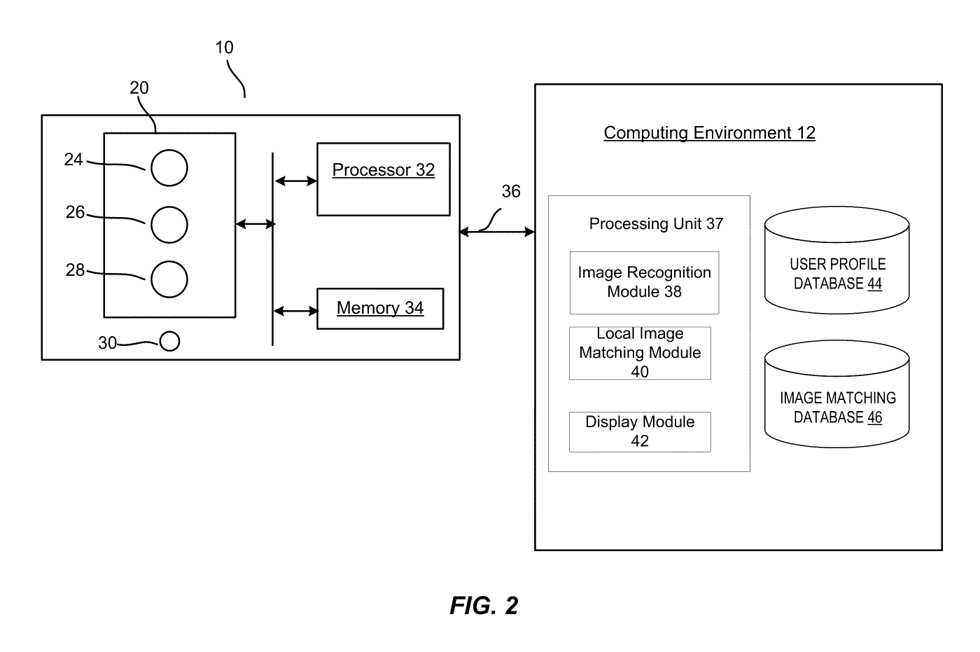

FIGS. 1A-2 illustrate a target recognition, analysis, and tracking system 10 which may be used by the disclosed technology to recognize, analyze, and/or track a human target such as a user 18. Embodiments of the target recognition, analysis, and tracking system 10 include a computing environment 12 for executing a gaming or other application, and an audiovisual device 16 for providing audio and visual representations from the gaming or other application. The system 10 further includes a capture device 20 for detecting gestures of a user captured by the device 20, which the computing environment receives and uses to control the gaming or other application. Each of these components is explained in greater detail below.

As shown in FIGS. 1A and 1B, in an example embodiment, the application executing on the computing environment 12 may be a boxing game that the user 18 may be playing. For example, the computing environment 12 may use the audiovisual device 16 to provide a visual representation of a boxing opponent 22 to the user 18. The computing environment 12 may also use the audiovisual device 16 to provide a visual representation of a player avatar 24 that the user 18 may control with his or her movements. For example, as shown in FIG. 1B, the user 18 may throw a punch in physical space to cause the player avatar 24 to throw a punch in game space. Thus, according to an example embodiment, the computer environment 12 and the capture device 20 of the target recognition, analysis, and tracking system 10 may be used to recognize and analyze the punch of the user 18 in physical space such that the punch may be interpreted as a game control of the player avatar 24 in game space.

Other movements by the user 18 may also be interpreted as other controls or actions, such as controls to bob, weave, shuffle, block, jab, or throw a variety of different power punches. Moreover, as explained below, once the system determines that a gesture is one of a punch, bob, weave, shuffle, block, etc., additional qualitative aspects of the gesture in physical space may be determined. These qualitative aspects can affect how the gesture (or other audio or visual features) is shown in the game space.

In example embodiments, the human target such as the user 18 may have an object. In such embodiments, the user of an electronic game may be holding the object such that the motions of the player and the object may be used to adjust and/or control parameters of the game. For example, the motion of a player holding a racket may be tracked and utilized for controlling an on-screen racket in an electronic sports game. In another example embodiment, the motion of a player holding an object may be tracked and utilized for controlling an on-screen weapon in an electronic combat game.

FIG. 2 illustrates an example embodiment of the capture device 20 that may be used in the target recognition, analysis, and tracking system 10. According to an example embodiment, the capture device 20 may be configured to capture video with depth information including a depth image that may include depth values via any suitable technique including, for example, time-of-flight, structured light, stereo image, or the like. According to one embodiment, the capture device 20 may organize the calculated depth information into “Z layers,” or layers that may be perpendicular to a Z axis extending from the depth camera along its line of sight.

As shown in FIG. 2, the capture device 20 may include an image camera component 22. According to an example embodiment, the image camera component 22 may be a depth camera that may capture the depth image of a scene. The capture device 20 may capture or observe a scene that may include one or more targets or objects in a field of view of the target recognition and analysis system 10. In an embodiment, the image of a scene captured by the capture device 20 may include a human target corresponding to, for example, a user of the target recognition and analysis system 10. The image may also include one or more objects held by the human target, such as, for example, a bat, ball, helmet or the like, one or more targets such as one or more secondary users in the scene or one or more objects such as a wall, a table, a monitor, a couch or a ceiling in the scene. In an embodiment, the capture device 20 may include a depth camera configured to obtain the depth image of the scene using any suitable technique such as time-of-flight analysis, structured light analysis, stereo vision analysis, or the like. The depth image may include a two-dimensional (2-D) pixel area of the captured scene where each pixel in the 2-D pixel area may represent a length in, for example, centimeters, millimeters, or the like of an object or a target in the captured scene from the camera.

As shown in FIG. 2, according to an example embodiment, the image camera component 22 may include an IR light component 24, a three-dimensional (3-D) camera 26, and an RGB camera 28 that may be used to capture the depth image of a scene. For example, in time-of-flight analysis, the IR light component 24 of the capture device 20 may emit an infrared light onto the scene and may then use sensors (not shown) to detect the backscattered light from the surface of one or more targets and objects in the scene using, for example, the 3-D camera 26 and/or the RGB camera 28. In some embodiments, pulsed infrared light may be used such that the time between an outgoing light pulse and a corresponding incoming light pulse may be measured and used to determine a physical distance from the capture device 20 to a particular location on the targets or objects in the scene. Additionally, in other example embodiments, the phase of the outgoing light wave may be compared to the phase of the incoming light wave to determine a phase shift. The phase shift may then be used to determine a physical distance from the capture device to a particular location on the targets or objects.

According to another example embodiment, time-of-flight analysis may be used to indirectly determine a physical distance from the capture device 20 to a particular location on the targets or objects by analyzing the intensity of the reflected beam of light over time via various techniques including, for example, shuttered light pulse imaging.

According to another embodiment, the capture device 20 may include two or more physically separated cameras that may view a scene from different angles, to obtain visual stereo data that may be resolved to generate depth information. The capture device 20 may further include a microphone 30. The microphone 30 may include a transducer or sensor that may receive and convert sound into an electrical signal. According to one embodiment, the microphone 30 may be used to reduce feedback between the capture device 20 and the computing environment 12 in the target recognition, analysis, and tracking system 10. Additionally, the microphone 30 may be used to receive audio signals that may also be provided by the user to control applications such as game applications, non-game applications, or the like that may be executed by the computing environment 12.

In an example embodiment, the capture device 20 may further include a processor 32 that may be in operative communication with the image camera component 22. The processor 32 may include a standardized processor, a specialized processor, a microprocessor, or the like that may execute instructions for receiving the depth image, determining whether a suitable target may be included in the depth image, converting the suitable target into a skeletal representation or model of the target, or any other suitable instruction. In an embodiment, the processor 32 may include executable instructions to determine whether a human target such as for example, a user of the target recognition and analysis system 10 is in the scene by segmenting the human target from an environment in the depth image captured by the capture device 20. The method of determining whether a human is in the scene is disclosed in U.S. patent application Ser. No. 12/475094 entitled “Environment and/or Target Segmentation”, filed 29 May 2009 and hereby incorporated herein by reference. The processor 32 may also include executable instructions to distinguish a user of the target recognition and analysis system 10 from one or more secondary users in the scene based on the user's profile data. A method of identifying users in a scene is disclosed in U.S. patent application Ser. No. 12/475,308, “Device for Identifying and Tracking Multiple Humans Over Time,” filed on May 29, 2009, and hereby fully incorporated herein by reference.

The capture device 20 may further include a memory component 34 that may store the instructions that may be executed by the processor 32, images or frames of images captured by the 3-D camera or RGB camera, or any other suitable information, images, or the like. According to an example embodiment, the memory component 34 may include random access memory (RAM), read only memory (ROM), cache, Flash memory, a hard disk, or any other suitable storage component. As shown in FIG. 2, in one embodiment, the memory component 34 may be a separate component in communication with the image capture component 22 and the processor 32. According to another embodiment, the memory component 34 may be integrated into the processor 32 and/or the image capture component 22.

As shown in FIG. 2, the capture device 20 may be in communication with the computing environment 12 via a communication link 36. The communication link 36 may be a wired connection including, for example, a USB connection, a Firewire connection, an Ethernet cable connection, or the like and/or a wireless connection such as a wireless 802.11b, g, a, or n connection. According to one embodiment, the computing environment 12 may provide a clock to the capture device 20 that may be used to determine when to capture, for example, a scene via the communication link 36.

Additionally, the capture device 20 may provide the depth information and images captured by, for example, the 3-D camera 26 and/or the RGB camera 28, and a skeletal model that may be generated by the capture device 20 to the computing environment 12 via the communication link 36. A processing unit 37 in the computing environment 12 may then use the skeletal model, depth information and captured images to perform the operations of the disclosed technology.

As will be discussed in greater detail below, the disclosed technology enables the generation of content information based on analyzing images from a scene captured by the capture device 20. The images of a scene may include a human target corresponding to, for example, a user of the target recognition and analysis system 10, one or more objects held by the human target, such as, for example, a bat, ball, helmet or the like, one or more other targets such as one or more secondary users in the scene or one or more objects such as a wall, a table, a monitor, a couch or a ceiling in the scene. The images of the scene are analyzed to detect one or more items of interest in the images. In an embodiment, the items of interest may include one or more brand identifiers in the images. The brand identifiers may include symbols or words identifying a brand, product or service associated with the brand identifier. User preference information for the brand identifiers may be assigned based on the analysis. The user preference information is analyzed to generate tailored content for the user. The tailored content may include, for example, providing a targeted product advertisement or a targeted broadcast event for the user. The tailored content may be displayed on a display device of the target recognition, analysis, and tracking system 10 to the user.

In an embodiment, the processing unit 37 in the computing environment 12 may include an image recognition module 38, a local image matching module 40, a display module 42, a user profile database 44 and an image matching database 46. The image recognition module 38, image matching module 40 and display module 42 may be implemented as software modules that include executable instructions to perform one or more operations of the disclosed technology. The image recognition module 38 may include executable instructions to analyze the images of a scene received from the capture device 20 to detect one or more items of interest such as one or more brand identifiers in the images. The image recognition module 38 may utilize a variety of image recognition techniques known in the art such as, for example, object recognition techniques, optical character recognition techniques or shape extraction techniques to perform image recognition. In an embodiment, the image recognition module 38 may process the images of a scene received from the capture device 20 to extract points of interest in the image, select a specific set of points of interest in the image for further analysis and identify an item of interest, such as one or more brand identifiers in the image based on the analysis.

The local image matching module 40 may include executable instructions to receive one or more brand identifiers detected by the image recognition module 38 and compare the detected brand identifiers to one or more known brand identifiers stored in the image matching database 46. The local image matching module 40 may further include executable instructions to assign user preference information to the brand identifiers based on the comparison. As used herein, user preference information may correspond to a user preference of a specific brand associated with a brand identifier. For example, if a brand identifier detected by the image recognition module 38 corresponds to a North Face™ logo, then user preference information associated with the North Face™ logo corresponds to the North Face™ brand. In an embodiment, the local image matching module 40 may also assign a brand affinity value to a detected brand identifier. In one embodiment, the brand affinity value refers to a frequency of use or wear by the user of the detected brand identifier captured by the capture device 20.

In another embodiment, the local image matching module 40 may also include executable instructions to receive one or more brand identifiers detected by the image recognition module 38 and compare the detected brand identifiers to one or more brand identifiers with existing user preference information. In an embodiment, user preference information for brand identifiers which have an existing user preference may be stored in the user profile database 44 along with the brand affinity value associated with the brand identifiers.

In another embodiment, the user preference information for a user of the target recognition analysis and tracking system 10 may also be assigned based on analyzing images of a scene captured by the capture device 20 that include one or more secondary users or other objects in the scene. For example, and as mentioned above, technology is disclosed by which the processor 32 in the capture device 20 may include executable instructions to distinguish a user of the target recognition and analysis system 10 from one or more secondary users in the scene based on the user's profile data. Accordingly, in one embodiment, the image recognition module 38 may also individually analyze items of interest, such as one or more brand identifiers in the images of the scene that include the user of the target recognition and analysis system 10 and items of interest in the images that include secondary users or other objects in the scene. For example, if no items of interest are identified in the images that include the user of the target recognition and analysis system 10, then user preference information may be assigned based on analyzing items of interest in the images in the scene that include one or more of the secondary users and the objects in the scene.

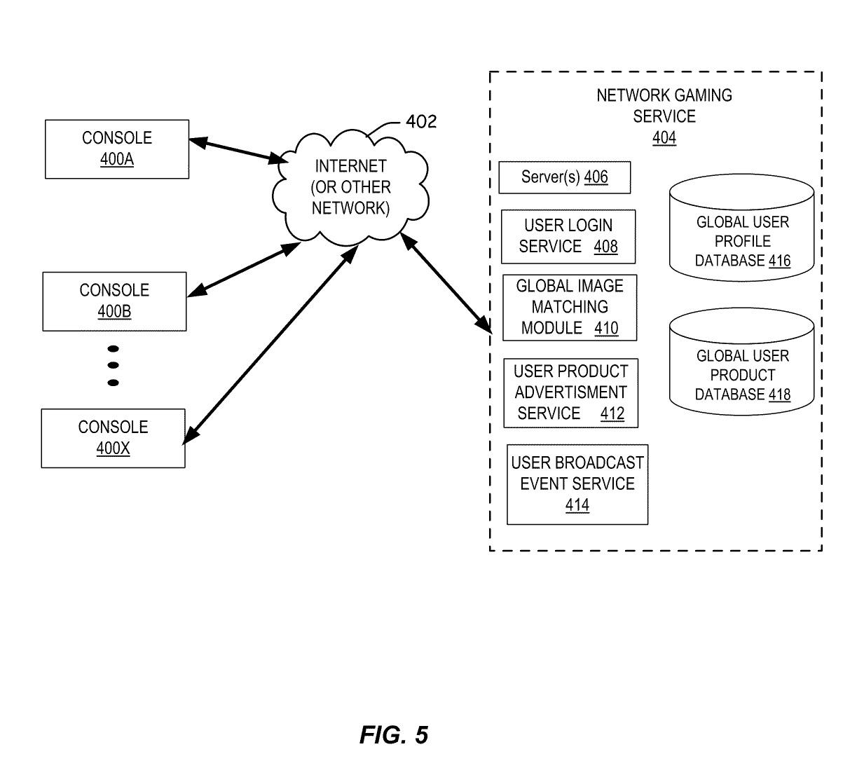

In one embodiment, the local image matching module 40 may include executable instructions to provide the user preference information to a network gaming service for further analysis. The local image matching module 40 may be configured to receive tailored content from the network gaming service based on the analysis. The network gaming service and the operations performed by the network gaming service are discussed in greater detail in FIG. 5.

Alternatively, the local image matching module 40 may also include executable instructions to generate tailored content for a user of the target, recognition and analysis system 10 based on the user preference information. For example, if the user preference information specifies a user's preference towards a particular brand, such as for example, the Starbucks™ brand, then tailored content in the form of, for example, a Starbucks™ logo may be provided to the user during gameplay. The tailored content may be presented, for example, as a banner within the game or as a trademark placed on products used during gameplay via a display device in the target recognition, analysis, and tracking system 10.

The display module 42 may include executable instructions to render the tailored content to the user on a display device of the target recognition, analysis, and tracking system 10. In an embodiment, and as will be discussed in greater detail below, the tailored content may include providing a targeted product advertisement or a targeted broadcast event to the user.

The user profile database 44 may include information about the user's account such as a unique identifier and password associated with the user and a console identifier that uniquely identifies the user of the target recognition and analysis system 10. In an embodiment, the user profile database 44 may include a list of brand identifiers which have an existing user preference, user preference information associated with the brand identifiers and a brand affinity value associated with the brand identifiers. The user profile database 44 may also include other information about the user such as game records and a friends list associated with the user. Game records may include information such as a gamer tag associated with the user and statistics for particular games, achievements acquired for particular games and/or other game specific information. The friends list may include a list of friends of the user who are also connected to or otherwise have user account records with a network gaming service.

The image matching database 46 may include a list of known brand identifiers. The image matching database 46 may be populated with a subset of brand identifiers received from a global user product database in the network gaming service, in an embodiment. The image matching database 46 may also include information associated with a brand identifier such as for example, brand information associated with the brand identifier. Brand information related to a brand identifier may include, for example, the specific brand associated with the brand identifier. For example, brand information associated with a brand identifier such as a North Face™ logo may include the specific brand, i.e., the North Face™ brand.

The target recognition and analysis system 10 may operate as a standalone system by connecting the system to an audiovisual device 16 (FIG. 1) such as a television, a video projector, or other display device to perform one or more of the operations of the disclosed technology, as discussed above. Alternatively, the target recognition and analysis system 10 may also communicate with a network gaming service and operate as a participant in a larger network gaming community as described in connection with FIG. 5, to perform one or more operations of the disclosed technology. For example, if a known brand identifier cannot be identified by the local image matching module 40, the local image matching module 40 may provide the brand identifier detected by the image recognition module 38 to a global image matching module in the network gaming service to perform image matching. Alternatively, both image recognition and image matching may be performed by the network gaming service, in another embodiment. The local image matching module 40 may also include executable instructions to provide the user preference information to the network gaming service and receive tailored content associated with a user from the network gaming service as discussed above. The network gaming service may include one or more software modules to perform the operations of the disclosed technology. The operations performed by the software modules in the network gaming service 404 are discussed in FIG. 5.

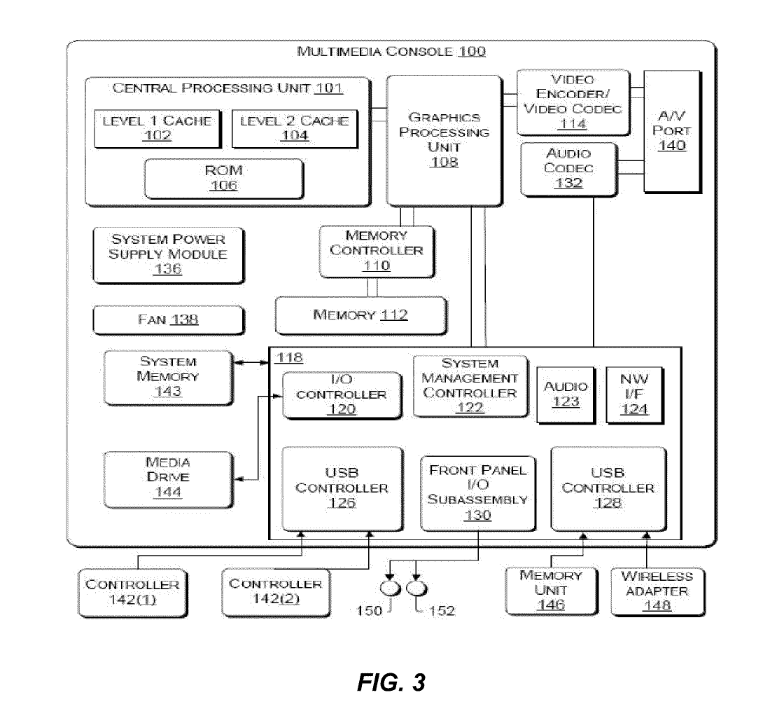

FIG. 3 illustrates an example embodiment of a computing environment used in the target recognition, analysis, and tracking system shown in FIGS. 1A-2. The computing environment such as the computing environment 12 described above with respect to FIGS. 1A-2 may be a multimedia console 100, such as a gaming console. As shown in FIG. 3, the multimedia console 100 has a central processing unit (CPU) 101 having a level 1 cache 102, a level 2 cache 104, and a flash ROM 106. The level 1 cache 102 and a level 2 cache 104 temporarily store data and hence reduce the number of memory access cycles, thereby improving processing speed and throughput. The CPU 101 may be provided having more than one core, and thus, additional level 1 and level 2 caches 102 and 104. The flash ROM 106 may store executable code that is loaded during an initial phase of a boot process when the multimedia console 100 is powered ON.

A graphics processing unit (GPU) 108 and a video encoder/video codec (coder/decoder) 114 form a video processing pipeline for high speed and high resolution graphics processing. Data is carried from the GPU 108 to the video encoder/video codec 114 via a bus. The video processing pipeline outputs data to an A/V (audio/video) port 140 for transmission to a television or other display. A memory controller 110 is connected to the GPU 108 to facilitate processor access to various types of memory 112, such as, but not limited to, a RAM.

The multimedia console 100 includes an I/O controller 120, a system management controller 122, an audio processing unit 123, a network interface controller 124, a first USB host controller 126, a second USB host controller 128 and a front panel I/O subassembly 130 that are preferably implemented on a module 118. The USB controllers 126 and 128 serve as hosts for peripheral controllers 142(1)-142(2), a wireless adapter 148, and an external memory device 146 (e.g., flash memory, external CD/DVD ROM drive, removable media, etc.). The network interface 124 and/or wireless adapter 148 provide access to a network (e.g., the Internet, home network, etc.) and may be any of a wide variety of various wired or wireless adapter components including an Ethernet card, a modem, a Bluetooth module, a cable modem, and the like.

System memory 143 is provided to store application data that is loaded during the boot process. A media drive 144 is provided and may comprise a DVD/CD drive, hard drive, or other removable media drive, etc. The media drive 144 may be internal or external to the multimedia console 100. Application data may be accessed via the media drive 144 for execution, playback, etc. by the multimedia console 100. The media drive 144 is connected to the I/O controller 120 via a bus, such as a Serial ATA bus or other high speed connection (e.g., IEEE 1394).

The system management controller 122 provides a variety of service functions related to assuring availability of the multimedia console 100. The audio processing unit 123 and an audio codec 132 form a corresponding audio processing pipeline with high fidelity and stereo processing. Audio data is carried between the audio processing unit 123 and the audio codec 132 via a communication link. The audio processing pipeline outputs data to the A/V port 140 for reproduction by an external audio player or device having audio capabilities.

The front panel I/O subassembly 130 supports the functionality of the power button 150 and the eject button 152, as well as any LEDs (light emitting diodes) or other indicators exposed on the outer surface of the multimedia console 100. A system power supply module 136 provides power to the components of the multimedia console 100. A fan 138 cools the circuitry within the multimedia console 100.

The CPU 101, GPU 108, memory controller 110, and various other components within the multimedia console 100 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 100 is powered ON, application data may be loaded from the system memory 143 into memory 112 and/or caches 102, 104 and executed on the CPU 101. The application may present a graphical user interface that provides a consistent user experience when navigating to different media types available on the multimedia console 100. In operation, applications and/or other media contained within the media drive 144 may be launched or played from the media drive 144 to provide additional functionalities to the multimedia console 100.

The multimedia console 100 may be operated as a standalone system by simply connecting the system to a television or other display. In this standalone mode, the multimedia console 100 allows one or more users to interact with the system, watch movies, or listen to music. However, with the integration of broadband connectivity made available through the network interface 124 or the wireless adapter 148, the multimedia console 100 may further be operated as a participant in a larger network community as described in FIG. 5.

When the multimedia console 100 is powered ON, a set amount of hardware resources are reserved for system use by the multimedia console operating system. These resources may include a reservation of memory (e.g., 16 MB), CPU and GPU cycles (e.g., 5%), networking bandwidth (e.g., 8 kbs), etc. Because these resources are reserved at system boot time, the reserved resources do not exist from the application's view. In particular, the memory reservation preferably is large enough to contain the launch kernel, concurrent system applications and drivers. The CPU reservation is preferably constant such that if the reserved CPU usage is not used by the system applications, an idle thread will consume any unused cycles.

With regard to the GPU reservation, lightweight messages generated by the system applications (e.g., popups) are displayed by using a GPU interrupt to schedule code to render popup into an overlay. The amount of memory required for an overlay depends on the overlay area size and the overlay preferably scales with screen resolution. Where a full user interface is used by the concurrent system application, it is preferable to use a resolution independent of the application resolution. A scaler may be used to set this resolution such that the need to change frequency and cause a TV resynch is eliminated.

After the multimedia console 100 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 101 at predetermined times and intervals in order to provide a consistent system resource view to the application. The scheduling is to minimize cache disruption for the gaming application running on the console.

When a concurrent system application requires audio, audio processing is scheduled asynchronously to the gaming application due to time sensitivity. A multimedia console application manager (described below) controls the gaming application audio level (e.g., mute, attenuate) when system applications are active.

Input devices (e.g., controllers 142(1) and 142(2)) are shared by gaming applications and system applications. The input devices are not reserved resources, but are to be switched between system applications and the gaming application such that each will have a focus of the device. The application manager preferably controls the switching of input stream, without knowledge of the gaming application's knowledge and a driver maintains state information regarding focus switches. The cameras 26, 28 and capture device 20 may define additional input devices for the console 100.

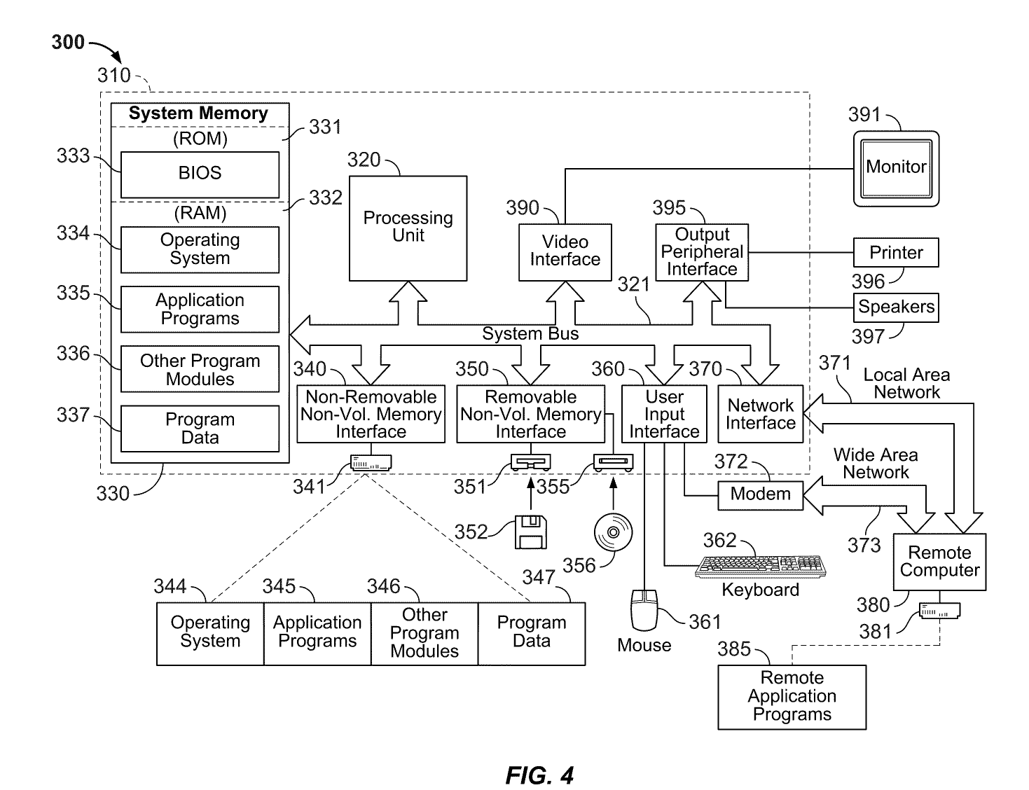

FIG. 4 illustrates another example embodiment of a computing environment that may be used in the target recognition, analysis, and tracking system shown in FIGS. 1A-2. FIG. 4 illustrates an example of a suitable computing system environment 300 such as a personal computer. With reference to FIG. 4, an exemplary system for implementing the invention includes a general purpose computing device in the form of a computer 310. Components of computer 310 may include, but are not limited to, a processing unit 320, a system memory 330, and a system bus 321 that couples various system components including the system memory to the processing unit 320. The system bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 310 typically includes a variety of computer readable media. Computer readable media can be any available media that can be accessed by computer 310 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 310. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 330 includes computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, is typically stored in ROM 331. RAM 332 typically contains data and/or program modules that are immediately accessible to and/or presently being operated on by processing unit 320. By way of example, and not limitation, FIG. 4 illustrates operating system 334, application programs 335, other program modules 336, and program data 337.

The computer 310 may also include other removable/non-removable, volatile/nonvolatile computer storage media. By way of example only, FIG. 4 illustrates a hard disk drive 340 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 341 is typically connected to the system bus 321 through an non-removable memory interface such as interface 340, and magnetic disk drive 351 and optical disk drive 355 are typically connected to the system bus 321 by a removable memory interface, such as interface 350.

The drives and their associated computer storage media discussed above and illustrated in FIG. 4, provide storage of computer readable instructions, data structures, program modules and other data for the computer 310. In FIG. 4, for example, hard disk drive 341 is illustrated as storing operating system 344, application programs 345, other program modules 346, and program data 347. Note that these components can either be the same as or different from operating system 334, application programs 335, other program modules 336, and program data 337. Operating system 344, application programs 345, other program modules 346, and program data 347 are given different numbers here to illustrate that, at a minimum, they are different copies. A user may enter commands and information into the computer 20 through input devices such as a keyboard 362 and pointing device 361, commonly referred to as a mouse, trackball or touch pad. Other input devices (not shown) may include a microphone, joystick, game pad, satellite dish, scanner, or the like. These and other input devices are often connected to the processing unit 320 through a user input interface 360 that is coupled to the system bus, but may be connected by other interface and bus structures, such as a parallel port, game port or a universal serial bus (USB). A monitor 391 or other type of display device is also connected to the system bus 321 via an interface, such as a video interface 390. In addition to the monitor, computers may also include other peripheral output devices such as speakers 397 and printer 396, which may be connected through a output peripheral interface 390.

The computer 310 may operate in a networked environment using logical connections to one or more remote computers, such as a remote computer 380. The remote computer 380 may be a personal computer, a server, a router, a network PC, a peer device or other common network node, and typically includes many or all of the elements described above relative to the computer 310, although only a memory storage device 381 has been illustrated in FIG. 4. The logical connections depicted in FIG. 4 include a local area network (LAN) 371 and a wide area network (WAN) 373, but may also include other networks. Such networking environments are commonplace in offices, enterprise-wide computer networks, intranets and the Internet.

When used in a LAN networking environment, the computer 310 is connected to the LAN 371 through a network interface or adapter 370. When used in a WAN networking environment, the computer 310 typically includes a modem 372 or other means for establishing communications over the WAN 373, such as the Internet. The modem 372, which may be internal or external, may be connected to the system bus 321 via the user input interface 360, or other appropriate mechanism. In a networked environment, program modules depicted relative to the computer 310, or portions thereof, may be stored in the remote memory storage device. By way of example, and not limitation, FIG. 4 illustrates remote application programs 385 as residing on memory device 381. It will be appreciated that the network connections shown are exemplary and other means of establishing a communications link between the computers may be used.

FIG. 5 is an example embodiment of the operation of the target recognition and analysis system shown in FIGS. 1A-2 in a larger network community, in accordance with the disclosed technology. In an embodiment, the computing environment 12 in the target recognition and analysis system 10, described above with respect to FIG. 1A-2, for example, may operate as a multimedia console, 400A in a larger network community to perform one or more operations of the disclosed technology. As shown in FIG. 5, multiple consoles 400A-400X may be coupled to a network 402 and can communicate with a network gaming service 404 having one or more server(s) 406 via network 402. The server(s) 406 may include a communication component capable of receiving information from and transmitting information to consoles 400A-X and may provide a collection of services that applications running on consoles 400A-X may invoke and utilize.

Consoles 400A-X may invoke user login service 408, which is used to authenticate a user on consoles 400A-X. During login, login service 408 obtains a gamer tag (a unique identifier associated with the user) and a password from the user as well as a console identifier that uniquely identifies the console that the user is using and a network path to the console. The gamer tag and password are authenticated by comparing them to a global user profile database 416, which may be located on the same server as user login service 408 or may be distributed on a different server or a collection of different servers. Once authenticated, user login service 408 stores the console identifier and the network path in the global user profile database 416 so that messages and information may be sent to the console.

In an embodiment, consoles 400A-X may invoke a global image matching module 410 in the network gaming service 404. The global image matching module 410 may include executable instructions to receive brand identifiers detected by the image recognition module 38 in the target recognition and analysis system 10 and compare the brand identifiers to one or more known brand identifiers stored in a global user product database 418. As discussed above, in one implementation of the disclosed technology, the process of image matching may be performed by the local image matching module 40 in the computing environment 12 of the target recognition and analysis system 10 as discussed in FIG. 2. Alternatively, image matching may also be performed by the global image matching module 410 in the network gaming service 404 in combination with the local image matching module 40, if, for example, a brand identifier cannot be identified in the image matching database 46 in the computing environment 12.

The global image matching module 410 may also include executable instructions to assign user preference information to a brand based on the comparison. As discussed above, user preference information assigned to a brand identifier corresponds to a user preference of the specific brand associated with a brand identifier. Based on the user preference information, a user on consoles 400A-X may be presented with tailored content on a display device on consoles 400A-X. In an embodiment, the global image matching module 410 may provide the user preference information to a user product advertisement service 412 and a user broadcast event service 414 in the network gaming service 404. The user product advertisement service 412 and the user broadcast event service 414 may include executable instructions to generate tailored content for the user based on the user preference information. The operations performed by the user product advertisement service 412 and the user broadcast event service 414 are discussed below. Alternatively, the local image matching module 40 in the computing environment 12 of the target recognition and analysis system 10 shown in FIG. 2 may also provide the user preference information to the user product advertisement service 412 and the user broadcast event service 414 upon identifying a brand identifier from the image matching database 46, as discussed in FIG. 2.

The global user product database 418 may include a list of known brand identifiers associated with a particular product, service or corporation. The global user product database 418 may be populated with a list of known brand identifiers based on items of interest observed from multiple scene images captured via each of the consoles 400A-X, in one embodiment. Alternatively, one or more of the server(s) 406 in the network gaming service 404 may communicate with a plurality of corporations or advertisement agencies over the network 402 to populate the global user product database 418 with a list of known brand identifiers. The global user product database 418 may include information associated with a brand identifier such as for example, brand information and one or more activities related to the brand identifier. In an embodiment, the global product database 418 may also include product information and similar brand information related to a brand identifier. One or more of the server(s) 406 in the network gaming service 404 may communicate with a plurality of corporations or advertisement agencies over network 402 to populate the global user product database 418 with activity information, product information and similar brand information for each brand identifier. Alternatively, third parties or advertisement agencies who wish to ensure that a variety of their products and images are recognized by the network gaming service 404 may provide information on their products and brands to the global user product database 418. For example, activity information related to a brand identifier such as a North Face™ logo may include activities such as outdoors, climbing, skiing and winter clothes, product information related to the North Face™ logo may include information about one or more North Face™ products and similar brand information may include information about brands similar to the North Face™ brand, such as one or more outdoor equipment brands or apparel brands.

The global user profile database 416 may include information about all the users on consoles 400A-X such as the users' account information and a console identifier that uniquely identifies a particular console that each user is using. The global user profile database 416 may also store user preference information and brand affinity values associated with brand identifiers for all the users on consoles 400A-X. The global user profile database 416 may also include information about users such as game records and a friends list associated with users as discussed in FIG. 2.

The user product advertisement service 412 may include executable instructions to generate tailored content for a user based on the user preference information received from either the user profile database 44 or the global user profile database 410 and the user's identification information stored in the global user profile database 416. In an embodiment, the user product advertisement database 412 may generate tailored content for the user based on the brand affinity value associated with a brand identifier. For example, the user product advertisement database 412 may receive user preference information associated with a detected brand identifier in addition to user preference information associated with a brand identifier with the highest brand affinity value from either the user profile database 44 or the global user profile database 410 to generate tailored content for the user.

In an embodiment, the user product advertisement service 412 may also generate tailored content based on activity information, product information and similar brand information in the global user product database 418. For example, if the user preference information assigned to a brand identifier specifies that a user has preference towards the North Face™ brand, the user product advertisement service 412 may retrieve product information and similar brand information related to North Face™ brand from the global user product database 418.

The tailored content generated by the user product advertisement service 412 may include providing a targeted product advertisement to the user based on the user preference information. For example, if the user preference information specifies that a user has a preference towards the Abercrombie and Fitch™ brand, then tailored content may be generated to provide the user with an Abercrombie and Fitch™ product offer, such as an Abercrombie and Fitch™ shirt. The tailored content generated by the user product advertisement service 412 may also include providing a related product offer, a genre related product offer or a location related product offer to the user. For example, if the user preference information specifies that a user has a preference towards the Seattle Seahawks™ brand, a related product offer may include providing the user with Seattle Seahawks™ game tickets, a genre related product offer may include providing the user with generic sports related products and a location related product offer may include providing the user with, for example, Seattle Mariners™ products and services. In addition, if the user preference information specifies that a user has a preference towards the Abercrombie and Fitch™ brand but the user preference information (as identified by a brand identifier with the highest brand affinity value) indicates a user's preference towards the Nike™ brand, then tailored content may be generated to provide the user with an Abercrombie and Fitch™ product offer as well as a Nike™ product offer.

In another embodiment, the user product advertisement service 412 may also include executable instructions to generate tailored content for a user's avatar (or a user's on-screen representation) based on the user preference information and the user's identification information stored in the user profile database 44 or the global user profile database 416. The tailored content may include a targeted product advertisement displayed as virtual articles to the user via the display device 16 in the target recognition and analysis system 10. The user may manipulate the series of virtual articles presented in the interface through movements captured by the target recognition and analysis system 10. The technique of provisioning virtual articles to a user in a game is disclosed in U.S. patent application Ser. No. 12/752,917 entitled “Motion Based Interactive Shopping Environment”, filed 1 April 2010 and hereby incorporated herein by reference.

The user product advertisement service 412 may include executable instructions to provide the tailored content to one or more consoles 400A-X. In an embodiment, the computing environment 12 in the target recognition and analysis system 10, described above with respect to FIG. 1A-2, may operate as a multimedia console, 400A to receive the tailored content from the user product advertisement service 412. Specifically, the display module 42 in the computing environment 12 may include executable instructions to receive the tailored content from the user product advertisement service 412 and render the tailored content on a display device such as, audiovisual device 16 in the target recognition, analysis, and tracking system 10 to the user.

In an embodiment, the network gaming service 404 may also include a user broadcast event service 414. The user broadcast event service 414 may include executable instructions to generate tailored content for a user based on the user preference information and the user's identification information stored in the user profile database 44 or global user profile database 416. The user broadcast service 414 may receive television content from one or more television content providers via the network 402 based on the user preference information to generate tailored content for the user. In an embodiment, the tailored content may include a targeted broadcast event that the user may be interested in. For example, if the user preference specifies that a user has brand affinity towards the Liverpool™ brand, the user broadcast event service may provide information related to an upcoming soccer game event to the user. The user broadcast event service 414 may also include executable instructions to provide the user with language specific commentary based on the user preference information.

The user broadcast event service 414 may include executable instructions to provide the tailored content to one or more consoles 400A-X. In an embodiment, the computing environment 12 in the target recognition and analysis system 10, described above with respect to FIG. 1A-2, may operate as a multimedia console, 400A to receive the tailored content from the user broadcast event service 414. Specifically, the display module 42 in the computing environment 12 may include executable instructions to receive the tailored content from the user broadcast event service 414 and render the tailored content on a display device such as, audiovisual device 16 in the target recognition, analysis, and tracking system 10 to the user.

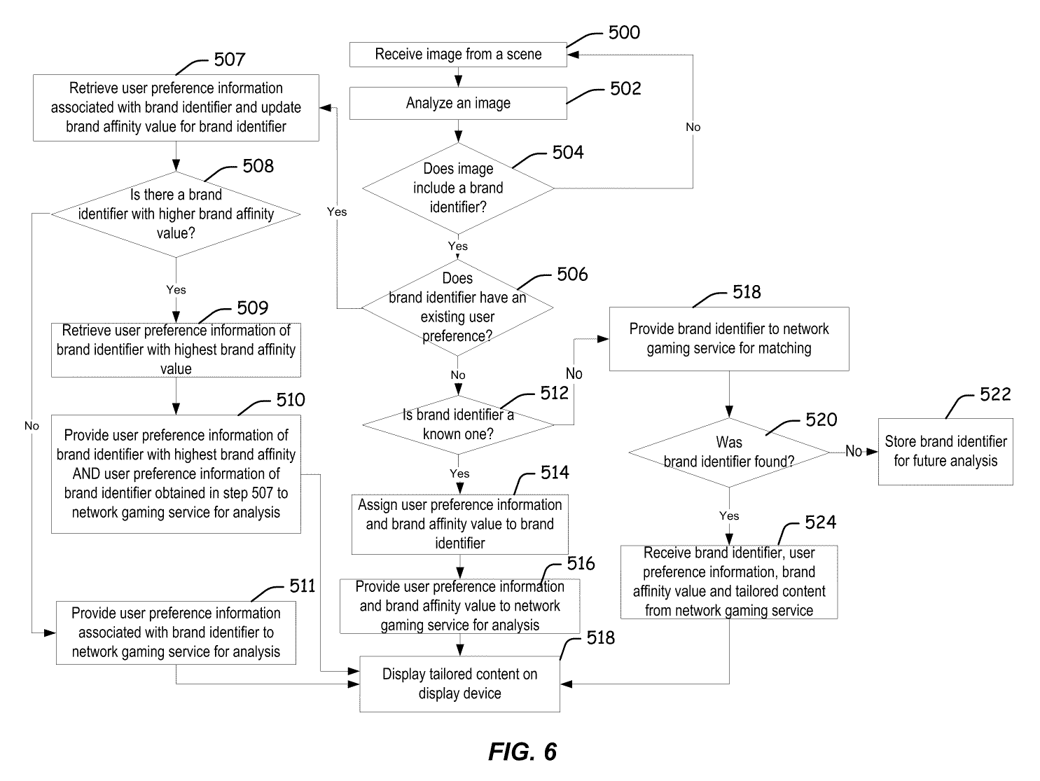

FIG. 6 illustrates an exemplary set of operations performed by the disclosed technology to generate tailored content for a user based on analyzing images in a scene captured by a capture device in the target recognition and analysis system. In one embodiment, the steps of FIG. 6 may be performed by one or more software modules, such as the image recognition module 38 and the image matching module 40 in the computing environment 12 in the target recognition and analysis system 10 shown in FIG. 2. The disclosed technology may provide a mechanism by which a user's privacy concerns are met while interacting with the target recognition and analysis system 10. In one embodiment, an opt-in by the user to the detection of objects in a scene in accordance with the present technology may be required before implementing the disclosed technology. A user wishing to interact with the target recognition and analysis system 10 may provide authentication to connect to the target recognition and analysis system 10. Authentication may be performed locally on the console or by transmitting user authentication credentials to the network gaming service 404. In accordance with the disclosed technology, upon a user's successful authentication, the user may be provided with an option to determine whether the user wishes to allow the target recognition and analysis system 10 to detect and analyze the user's preferences. If the user wishes to allow the system to generate and analyze user preference information, one or more of the following operations discussed below may be performed by the software modules in the computing environment 12 to identify a user's preferences and generate tailored content for the user.

In step 500, images of a scene captured by the capture device are received. The images of a scene may include a human target corresponding to, for example, a user of the target recognition and analysis system 10, one or more objects held by the human target, such as, for example, a bat, ball, helmet or the like, one or more secondary users in the scene or one or more objects such as a wall, a table, a monitor, a couch or a ceiling in the scene. In step 502, an image is analyzed to detect one or more items of interest such as one or more brand identifiers in the image. In an embodiment, the image recognition module 38 in the computing environment 12 may include executable instructions to perform the image recognition to detect one or more brand identifiers in the image. In step 504, a check is made to determine if the image includes one or more brand identifiers. As mentioned above, in one embodiment, brand identifiers may include symbols or words identifying a brand, product or service associated with the brand identifier. If the image does not include one or more brand identifiers, then processing continues to receive the next image captured by the capture device 20 at step 500. If the image includes one or more brand identifiers, then at step 506, a check is made to determine if the detected brand identifier has an existing user preference. If it is determined that the brand identifier has an existing user preference, then the user preference information associated with the brand identifier is retrieved and the brand affinity value associated with the brand identifier is updated in step 507.

In an embodiment, a further check may be made at step 508 to determine if there exists a brand identifier stored in the user profile database 44 which has a higher brand affinity value than the brand affinity value associated with the brand identifier detected at step 507. If this is true, user preference information associated with the brand identifier with the highest brand affinity value is also retrieved in step 509. In step 510, the user preference information associated with the brand identifier with the highest brand affinity obtained at step 509 and the user preference information associated with the brand identifier obtained in step 507 is provided to the network gaming service for analysis. In step 518, tailored content is displayed on a display device to the user. If at step 508 it is determined that the brand affinity value associated with the brand identifier obtained at step 507 has the highest affinity value, then the user information associated with the brand identifier obtained in step 507 is provided to the network gaming service for analysis in step 511. In step 518, tailored content is displayed on a display device to the user.

If at step 506, it is determined that the detected brand identifier does not have an existing user preference, then a check is made in step 512 to determine if the detected brand identifier corresponds to a known brand identifier by comparing the detected brand to one or more known brand identifiers stored in the image matching database 46. If this is true, then user preference information and a brand affinity value for the detected brand identifier is assigned at step 514. In step 516, the user preference information is provided to the network gaming service for analysis. In step 518, tailored content is displayed on a display device to the user.

In an embodiment, the user preference information may be provided to the network gaming service 404 to generate tailored content for the user as discussed above. In another embodiment, the tailored content for the user may also be generated locally by the local image matching module 40 based on the user preference information, as discussed in FIG. 2.

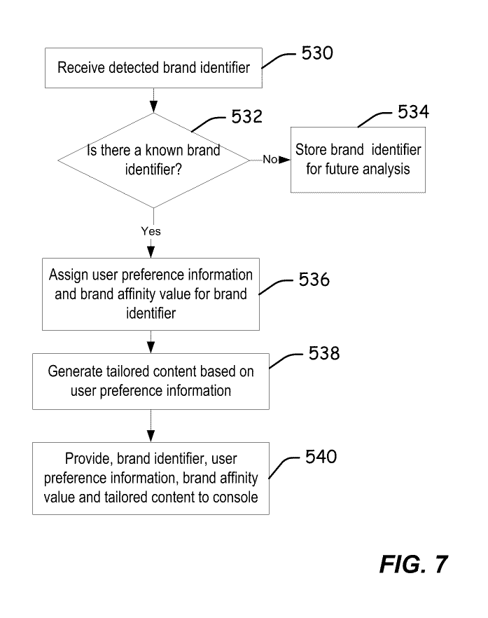

If at step 512, it is determined that the detected brand identifier does not either correspond to a brand identifier with an existing user preference or to a known brand identifier, then the detected brand identifier is provided to the network gaming service 404 to perform image matching. The operations performed by the network gaming service 404 are described in FIG. 7. In step 520, a check is made to determine if a known brand identifier was found in the global user product database 418 in the network gaming service 404. If this is true, then user preference information, the brand affinity value and the tailored content associated with the detected brand identifier is received from the network gaming service 404 in step 524. In step 518, the tailored content is displayed on a display device in the target recognition and analysis system 10 to the user. If at step 512 it is determined that the detected brand identifier does not correspond to any known brand identifier, then the detected brand identifier may be stored in the user profile database 44 or the global user profile database 416 for future analysis in step 522. Steps (500-524) of FIG. 6 may be repeated for each image received from the capture device 20.

FIG. 7 illustrates an exemplary set of operations performed by the network gaming service to generate tailored content for a user. In an embodiment, and as discussed in FIG. 6, if the detected brand identifier obtained in step 504 in FIG. 6 does not correspond to either a brand identifier with an existing user preference (step 506) or to a known brand identifier (step 512), the detected brand identifier may be provided to the global image matching module 410 in the network gaming service 404 to perform image matching (step 518). In step 530, one or detected brand identifiers are received. In step 532, a check is made to determine if the detected brand identifier corresponds to a known brand identifier. In an embodiment, the global image matching module 410 in the network gaming service 404 may include executable instructions to compare the detected brand identifier to one or more known brand identifiers stored in the global user product database 418. If the detected brand identifier corresponds to a known brand identifier, then user preference information and a brand affinity value associated with the detected brand identifier is assigned in step 536. If the detected brand identifier does not correspond to a known brand identifier, then the brand identifier may be stored in the global user profile database 416 for future analysis in step 534. In step 538, tailored content for the user based on the user preference information is generated. In an embodiment, the user product advertisement service 412 and the user broadcast event service 414 may include executable instructions to generate tailored content for the user based on the user preference information, brand affinity value and the user's identification information stored in the global user profile database 416 as discussed in FIG. 5. In step 540, the network gaming service 404 provides the detected brand identifier, user preference information, brand affinity value and tailored content to a console such as the computing environment in the target recognition and analysis system 10.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It is intended that the scope of the invention be defined by the claims appended hereto.

What is claimed is:

1. A computer implemented method for generating tailored content for a user based on analyzing images in a scene comprising:
receiving one or more images from a scene captured by a capture device in a target recognition and analysis system, wherein the one or more images include a user of the target recognition and analysis system;
analyzing the one or more images to detect one or more brand identifiers in the images;
comparing one or more detected brand identifiers to at least one or more known brand identifiers;
assigning user preference information to the one or more detected brand identifiers based on the comparing;
generating tailored content for the user based on the user preference information; and
rendering the tailored content on a display device of the target recognition and analysis system to the user.

2. The computer implemented method of claim 1 wherein the brand identifier includes at least one of symbols or words identifying a brand, product or service associated with the brand identifier.

3. The computer implemented method of claim 1 wherein assigning the user preference information to the one or more detected brand identifiers further comprises assigning a brand affinity value to the one or more detected brand identifiers.

4. The computer implemented method of claim 3 wherein the user preference information corresponds to a user preference of a specific brand associated with the detected brand identifier.

5. The computer implemented method of claim 3 wherein the brand affinity value corresponds to a frequency of use or wear by the user of the detected brand identifier.

6. The method of claim 1 comprising comparing one or more detected brand identifiers to at least one or more brand identifiers with existing user preference information.

7. The method of claim 1 wherein generating the tailored content for the user comprises providing at least one of a targeted product advertisement or a targeted broadcast event to the user.

8. The method of claim 1 wherein generating the tailored content for the user comprises providing at least one of a related product offer, a genre related product offer and a location related product offer to the user.

9. The method of claim 1 wherein generating the tailored content for the user comprises providing a targeted product advertisement to an avatar associated with the user.

10. The method of claim 7 wherein rendering the tailored content on a display device of the target recognition and analysis system comprises rendering at least one of the targeted product advertisement or the targeted broadcast event to the user.

11. A computer implemented method for generating tailored content for a user based on analyzing images of a scene comprising:
receiving one or more images from a scene captured by a capture device, wherein one or more of the images include a user of the target recognition and analysis system, one or more secondary users and one or more objects in the scene;
analyzing the one or more images to detect one or more items of interest in the images that include the user of the target recognition and analysis system, wherein the one or more items of interest include one or more brand identifiers in the one or more images;
analyzing the one or more images to detect one or more items of interest in the images that include at least one of the one or more secondary users and one or more of the objects in the scene, wherein the one or more items of interest include one or more brand identifiers in the one or more images;
assigning user preference information based on at least one of an analysis of the items of interest in the one or more images that include the user or the items of interest in the one or more images that include the one or more secondary users and the one or more objects;
generating tailored content for the user of the target recognition and analysis system based on the user preference information, wherein generating the tailored content comprises providing at least one of a targeted product advertisement and a targeted broadcast event to the user; and
rendering the tailored content on a display device of the target recognition and analysis system to the user.

12. The computer implemented method of claim 11 wherein the brand identifiers include at least one of symbols or words identifying a brand, product or service associated with the brand identifiers.

13. The computer implemented method of claim 11 wherein the user preference information corresponds to a user preference of a specific brand associated with the brand identifiers.

14. The computer implemented method of claim 11 wherein generating the tailored content is based on at least one of activity information, brand information, product information and similar brand information associated with the brand identifiers.

15. The method of claim 1 wherein generating the tailored content for the user comprises providing at least one of a related product offer, a genre related product offer and a location related product offer to the user of the target recognition and analysis system.

16. A gaming system comprising:
a network gaming service in communication with a plurality of consoles, wherein the network gaming service comprises a:
a global image matching module for assigning user preference information based on an analysis of one or more items of interest in one or more images of a scene captured by a capture device;
a user product advertisement service for providing a targeted product advertisement to one or more users on the plurality of consoles based on the user preference information; and
a user broadcast event service for providing a targeted broadcast event to the one or more users on the plurality of consoles based on the user preference information.

17. The gaming system of claim 16, wherein the one or more items of interest comprise one or more brand identifiers in the one or more images.

18. The computer implemented method of claim 17 wherein the brand identifiers include at least one of symbols or words identifying a brand, product or service associated with the brand identifiers.

19. The gaming system of claim 16 wherein the analysis is based on comparing the one or more images of the scene to one or more stored images to assign the user preference information.

20. The gaming system of claim 16 wherein the user product advertisement service provides at least one of a related product offer, a genre related product offer and a location related product offer to the users on the plurality of consoles.
